(19) United States
(12) Patent Application Publication
(10) Pub. No.: US 2011/0111735 A1
(43) Pub. Date: May 12, 2011

(54) PHONE HOLD MECHANISM

(75) Inventor: Craig A. Pietrow, Saratoga, CA (US)

(73) Assignee: Apple Inc., Cupertino, CA (US)

(21) Appl. No.: 12/613,646

(22) Filed: Nov. 6, 2009

(51) Int. Cl. H04M 3/42

(52) U.S. Cl. 455/414.1; 455/567

(57) ABSTRACT

A portable communication device holds an incoming call for a user when the user is temporarily unavailable to pick up the call. In response to an incoming call signal and an indication from the user to hold the call, the portable communication device answers the call and plays back a pre-recorded message to the caller while holding the call. The call can be held until the user picks up the call. If the user is on another call when the incoming call arrives, the portable communication device answers the incoming call with a pre-recorded message and holds the incoming call, as well as concurrently maintains uninterrupted communication on the in-progress call. The user can also enter an estimated hold time, which is announced to the caller. Other embodiments are also described and claimed.

### FIELD

An embodiment of the invention relates to a phone hold mechanism of a portable communication device such as a mobile phone. Other embodiments are also described.

### BACKGROUND

An incoming call to a mobile phone may sometimes arrive at an inconvenient time. For example, a user of a mobile phone may receive a call during a meeting. The user may prefer to pick up the call only when he is able to extricate himself from the meeting. However, if the user does not pick up the call within a pre-set time period (e.g., with a set number of ring tones or vibration cycles), the call is automatically re-directed to voicemail.

Consider the following scenario, which is quite typical in daily mobile phone usage. A user is alerted that an incoming call has arrived when he is temporarily unable to answer the call. The call is re-directed to voicemail before the user can pick up the phone. The user tries to call back the caller, while the caller is leaving a message on the voicemail, and is therefore re-directed to the caller's voicemail. As a result, the two are talking to each other's voicemail even though they are available and intend to talk to each other live.

Sometimes, the caller may not want to leave a message and simply hangs up after being re-directed to voicemail. The caller may then be temporarily unavailable when the user, who has seen the missed call on her mobile phone, returns the call. Thus, there may be a long delay before the user can finally get in touch with the caller. It can be frustrating to the user of the mobile phone that his temporary inability to pick up the initial incoming call would cause so much inconvenience. This could be useful in a situation where both answering a call and listening to a resulting voicemail may both be disturbing to the user's current environment.

### SUMMARY

An embodiment of the invention is directed to a portable communication device, which, in response to an incoming call signal and an indication from the user to hold the call, answers the call and plays back a pre-recorded message to the caller while holding the call. The call can be held until the user picks up the call. The pre-recorded message can be selected by the user from a list of options presented to the user after the incoming call arrives, or pre-selected by the user before the incoming call arrives.

In another embodiment, the user of the portable communication device is on another call when the incoming call arrives. The portable communication device answers the incoming call with a pre-recorded message and holds the incoming call, and concurrently maintains uninterrupted communication on the in-progress call.

In yet another embodiment, the pre-recorded message includes a request for the caller to speak. A speech-to-text converter in the portable communication device then converts the caller's speech to text, and the text is displayed on a display screen of the portable communication device. Thus, the user does not need to speak into the phone, and is able to read the message from the caller.

In another embodiment, the user can enter an estimated hold time for the call being held. An adjustable hold time indicator can be shown on the display screen. The user can adjust the hold time by sliding his finger on a touch panel or on a touch screen where the indicator is displayed, tapping on the indicator, dragging an adjustment tab on the indicator, or entering physical keystrokes. The estimated hold time can be announced to the caller.

The portable communication device may be configured or programmed by its user, to support one or more of the above-described phone hold features.

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one.

FIG. 1 is a diagram of a portable communication device (also referred to as a receiving phone) operating to receive an incoming phone call.

FIG. 2 is a block diagram illustrating an embodiment of the components of the receiving phone.

FIG. 3 is a timeline of events that occur while processing an incoming phone call at the receiving phone.

FIGS. 4A-4C show an example of a receiving phone that provides a sequence of options for a user to place an incoming call on hold.

FIGS. 5A-5B show an example of a receiving phone that places an incoming phone call on hold while communicating on another call.

FIG. 6 shows an example of a receiving phone communicating with a caller of a held call using text messages.

### DETAILED DESCRIPTION

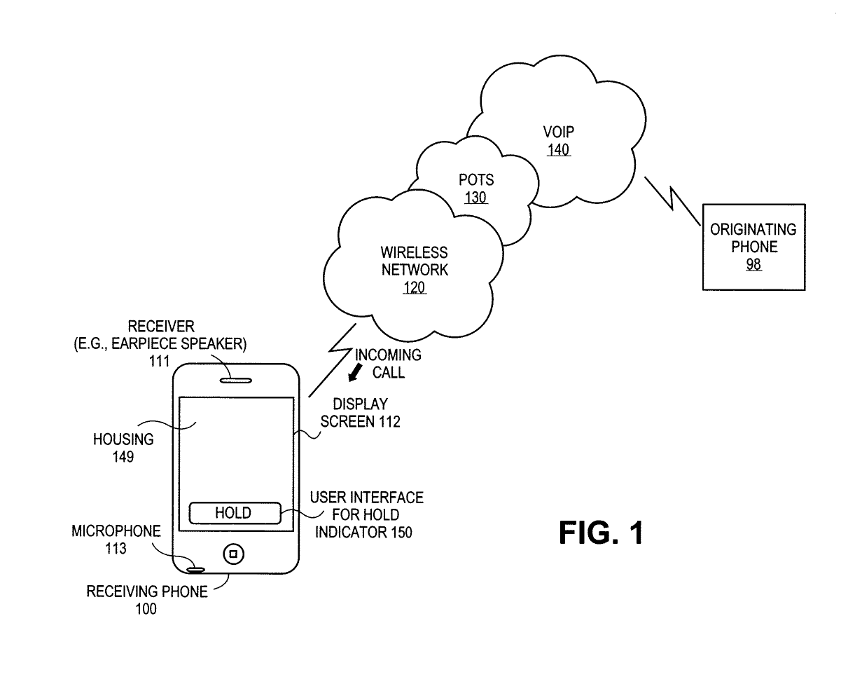

FIG. 1 is a diagram illustrating a communication environment in which a receiving phone 100 receives a phone call from an originating phone 98 over a communication network. The term “phone” herein broadly refers to various two-way, real-time communication devices, e.g., landline plain-old-telephone system (POTS) end stations, voice-over-IP end stations, cellular handsets, smart phones, etc. In one embodiment, the receiving phone 100 is a portable communication device that provides two-way, real-time mobile telephonic connections. For example, the receiving phone 100 can be a mobile phone or a mobile multi-functional device that can send and receive voice signals in a cellular communication network.

The receiving phone 100 communicates with the originating phone 98 over a communication network, for example, a wireless network 120, POTS 130, and a VOIP network 140. Communications between the receiving phone 100 and the wireless network 120 may be in accordance with known cellular telephone communication network protocols including, for example, global system for mobile communications (GSM), enhanced data rate for GSM evolution (EDGE), and worldwide interoperability for microwave access (WiMAX). The receiving phone 100 may also have a subscriber identity module (SIM) card, which is a detachable smart card that contains the subscription information of its user, and may also contain a contacts list of the user. The user or caller may own the receiving phone 100 or may otherwise be its primary user. The receiving phone 100 may be assigned a unique address by a wireless telephony network operator, such as an eleven digit international telephone number or an Internet Protocol, IP, address.

The exterior of the receiving phone 100 is made of a housing 149 within which are integrated several components including a display screen 112, a receiver 111 (e.g., an earpiece speaker for generating sound) and a microphone 113 (e.g., a mouthpiece for picking up sound). The receiving phone 100 also includes a user input interface for receiving user input. In one embodiment, the user input interface includes a “hold” indicator 150, which may be a physical button or a virtual button. The physical button may be a dedicated “hold” button, or one or more buttons identified by the text shown on the display screen 112 (e.g., “press ∩∩ to hold this call”). In an embodiment where the “hold” indicator 150 is a virtual button, the virtual button may be implemented on a touch-sensing panel that includes sensors to detect a user's touch and motion. The sensors may be based on resistive sensing, capacitive sensing, optical sensing, force sensing, surface acoustic wave sensing, and/or other sensing techniques. The coordinates of the sensors that respond to the user's touch and motion represent a specific user input. In one embodiment, the touch-sensing panel can be embedded within the display screen 112. When an incoming call arrives, the display screen 112 shows a graphical “hold” button that can be pressed by the user to hold the incoming call. In an alternative embodiment, the touch-sensing panel can be separate from the display screen 112, and can be used by the user to direct a cursor on the display screen 112 to select a graphical “hold” button shown on the display screen 112.

Turning to the originating phone 98, the originating phone 98 from which an incoming call originates need not be a mobile device, but instead may be a land-based device that is coupled to a telephony network through wires or cables. The originating phone 98 may be identified with a unique address, such as a telephone number within the public switched telephone network. The originating phone 98 may also have an Internet protocol (IP) address if it performs calls through a voice over IP (VOIP) protocol. The originating phone 98 may be a cellular handset, a plain old telephone service (POTS), analog telephone, a VOIP telephone station, or a desktop or notebook computer running telephony software.

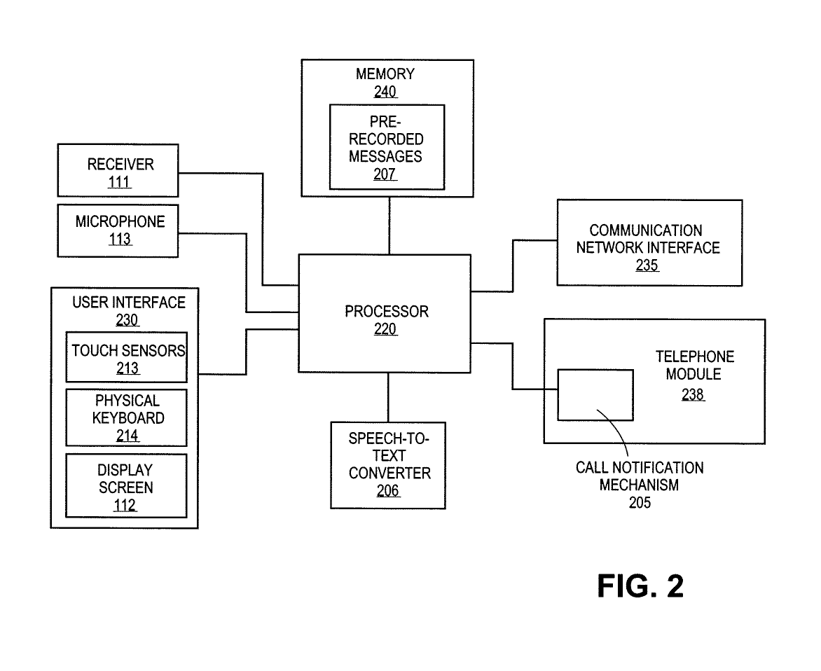

FIG. 2 is a block diagram illustrating an embodiment of the receiving phone 100. The receiving phone 100 includes a communication network interface 235 for receiving and transmitting communication signals, e.g., audio, video and/or data signals. The receiving phone 100 also includes the receiver 111 for generating audio signals in response to an incoming call signal, the microphone 113 for picking up audio signals from the user, and a user interface 230 that includes the display screen 112 and touch sensors 213 for sensing user's touch and motion. In some embodiments, the receiving phone 100 also includes a physical keyboard 214 for receiving keystrokes input from the user. In alternative embodiments, the receiving phone 100 may include a virtual keyboard implemented by the touch sensors 213. The touch sensors 213 may be embedded in the display screen 112, or may be separate from the display screen 112. Additional circuitry, including a combination of hardware circuitry and software, can be included to obtain the needed functionality described below. These are not described in detail as they would be readily apparent to those of ordinary skill in the art of mobile phone circuits and software.

In one embodiment, the receiving phone 100 also includes a telephone module 238 which is responsible for coordinating various tasks involved in a phone call. The telephone module 238 may be implemented with hardware circuitry, or may be implemented with one or more pieces of software or firmware that are stored within memory 240 in the receiving phone 100 and executed by a processor 220. Although one processor 220 is shown, it is understood that any numbers of processors may be included in the receiving phone 100. The telephone module 238 coordinates tasks such as receiving an incoming call signal, directing the call signal to a call notification mechanism 205 to alert the user of the incoming call, answering the call for the user, playing back pre-recorded messages 207 in the memory 240 and holding the call. After the call is picked up by the user, the telephone module 238 can direct audio signals (between the microphone 113 and the caller, and between the caller and the receiver 111 or a speakerphone), and end the call.

In one embodiment, the call notification mechanism 205 includes an actuator that vibrates the housing 149 (FIG. 1) of the receiving phone 100 to alert the user of an incoming call. The call notification mechanism 205 can also cause the processor 220 to retrieve a stored ring tone in response to an incoming call signal, which triggers a ringer of the receiving phone 100 to generate ring tones. Alternatively or additionally, the call notification mechanism 205 can cause, in response to an incoming call signal, the display screen 112 and/or other visual indicators to flash.

Still referring to FIG. 2, in one embodiment, the receiving phone 100 includes a speech-to-text converter 206 to convert a speech signal into text. The speech-to-text converter 206 may be implemented with hardware circuitry, or may be implemented with software or firmware stored within memory 240 in the receiving phone 100 and executed by the processor 220. The speech-to-text converter 206 identifies the words in an input speech signal based on one or more speech recognition techniques, and causes the display screen 112 to show the recognized words in text. The speech-to-text converter 206 can convert the user's speech into text for transmission to a remote party, and can also convert the speech signal of the remote party into text for display on the display screen 112. The speech-to-text converter 206 may be activated and deactivated by the user by an input to the user interface 230 (e.g, a physical button or a virtual button).

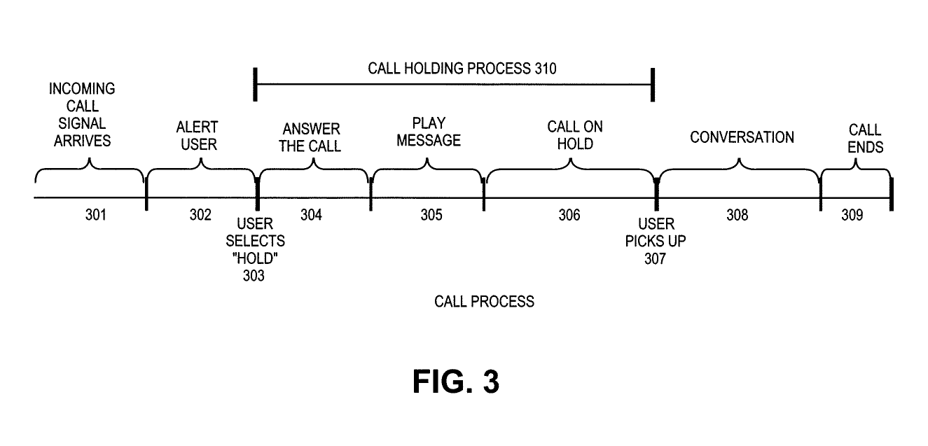

An example timeline for operating the receiving phone 100 for holding a call is shown in FIG. 3. Referring to FIG. 3, operation may begin when the receiving phone 100 receives a signal from a telephony or communication network representing the arrival of an incoming call; that is, a signal which triggers the familiar “ringing” event in the receiving phone 100. This occurred because a called “dialed” the address (generically referred to here as the phone number) assigned to the receiving phone 100. Upon receiving the incoming call signal, the receiving phone 100 alerts the user of the incoming call (302). The alert may be in the form of an actuator vibrating the housing of the receiving phone 100 if the phone has been set to a vibration mode. Alternatively, the alert may be in the form of ring tones, flashing backlight of the display screen 112, or other audio or visual indications. In the meantime or simultaneously, the receiving phone 100 also presents the user with a number of options to respond to the incoming signal: accept (i.e., pick up) the call, hold the call, or re-direct the call to a voicemail (VM) system.

If the user picks up the call, a communication link is established between the user and the caller for the two parties to begin a conversation. If the user selects to re-direct the call to a voicemail system, the incoming call will be picked up by the voicemail system which will then record a message from the caller. The message left by the caller may be stored in the memory 240 of the receiving phone 100, or it may be stored in a remote voicemail server. Typically, once the call is re-directed to the voicemail system, the user cannot stop the call redirection process to pick up the call and speak live with the caller. After the caller finishes leaving the message and hangs up the originating phone, the user may retrieve the message of the caller from the voicemail system and/or return a call to the caller.

If the user selects to hold the call (303), a call holding process (310) starts. In response to the user's indication to hold the call, the receiving phone 100 answers the incoming call (304) and then plays back a pre-recorded message to the caller (305). The pre-recorded message may indicate that the user is temporarily unavailable to answer the call, and ask the caller to stay on the line for a short time. After the pre-recorded message is played, the receiving phone 100 continues to hold the incoming call (306) until the user picks up the call (307). The user can pick up the call by pressing a call pickup button (e.g., a physical button or a virtual button) on the receiving phone 100. Once the user picks up the call, the call holding process 310 ends. The two parties are then “live” and so can start a conversation (308) until one or both of the parties end the call (309). Alternatively, the call holding process 310 may end when one of the two parties decides to no longer stay on hold and terminate the call.

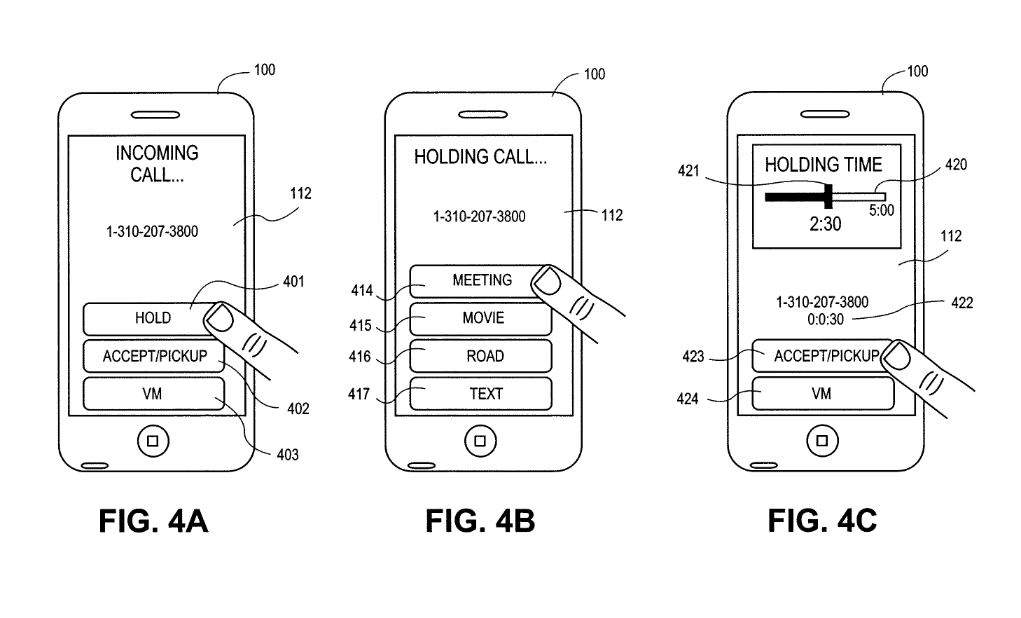

FIGS. 4A-4C show an example of the receiving phone 100 that provides a sequence of options for a user to place an incoming phone call on hold. In one embodiment shown in FIG. 4A, in response to the arrival of an incoming call signal, the receiving phone 100 displays “INCOMING CALL . . . ” on the display screen 112 and the number assigned to the caller of the incoming call. In one embodiment where the receiving call 100 stores a list of contacts including their nicknames and numbers, the display screen 112 may show the nickname of the caller in addition to or instead of the calling number. The display screen 112 may also present a number of options for the user to choose. The options may include: hold 401, accept (i.e., pick up) 402 and voicemail 403. The user may select one of these options using a physical button or a virtual button.

Once the user selects the hold option 401, the display screen 112 may show “HOLDING CALL . . . ” to indicate that the call holding process has started. The display screen 112 can also show the calling number and/or the nickname of the caller. In one embodiment shown in FIG. 4B, the receiving phone 100 may provide the user with a number of additional options, each associated with a different pre-recorded message. For example, an option 414 may correspond to a pre-recorded message indicating that the user is currently in a meeting, but will step out of the meeting shortly to answer the call. Similarly, options 415 and 416 may indicate that the user is in a movie and on the road, respectively, but will come to the phone shortly. An option 417 may correspond to a pre-recorded message indicating that the user cannot talk on the phone at this moment, but is able to read text. Thus, the caller can send a text message to the user, or can have the receiving phone 100 convert his speech into text for the user to read on the display screen 112. Further details regarding the use of the option 417 will be provided in connection with FIG. 6. In the pre-recorded message associated with any of the above-described options 414-417, it may also be indicated to the caller that the caller can opt-out of a hold and jump to voicemail at anytime during the hold. For example, the pre-recorded message can indicate to the caller that the voicemail bailout option can be reached by pressing # at any time during the hold. More or different options may be provided by the receiving phone 100.

In an alternative embodiment, the receiving phone 100 may display the options 414-417 at the same time as the initial hold/pickup/voicemail decision of 401-403. In another embodiment, the receiving phone 100 may be configured to associate a particular default message with a caller based on the phone number or the caller ID of the caller. Thus, when the caller calls the receiving phone 100 and is to be placed on hold, the default message associated with the caller will be played. In yet another embodiment, before the user is engaged in a situation in which he will be temporarily unable to answer a call (e.g., in a meeting), the user may select a pre-recorded message indicating that he is in a meeting. Then once the user selects the hold option 401, a pre-recorded message indicating that the user is in a meeting will be automatically played without the user further selecting the meeting option 414.

Once the user indicates to hold the call, the receiving phone 100 plays back a default or a selected message to the caller while holding the incoming call. The message sent to the caller can incorporate an estimated length of hold time as indicated by the user. Referring to FIG. 4C, the user may enter an estimated hold time with an estimated hold time indicator 420 provided on the display screen 112. For example, the estimated hold time indicator 420 may be a slide bar that can be adjusted by the user to indicate the estimated hold time. The entire length of the slide bar may represent a maximum hold time (e.g., 5 minutes), which can be configured by the user. The slide bar may be adjusted by a configurable increment (e.g., 10 seconds). In the embodiment of FIG. 4C, the user can move an adjustment tab 421 along the slide bar to indicate an estimated hold time in the increment of 10 seconds up to a maximum of 5 minutes. The user may move an adjustment tab 421 by dragging the tab 421, by sliding a finger near the slide bar, by tapping on the surface of the display screen 112 one or more times, or by pressing a key on a physical or virtual keyboard. Each tap or keystroke may represent an increment of the estimated hold time (e.g., 10 seconds). The receiving phone 100 detects the position of the adjustment tab 421, converts the position into a length of time, and incorporates the length of time into the pre-recorded message played to the caller. For example, the user may pre-record a message to say “I am in a meeting right now, but please hold and I will answer your call shortly.” The receiving phone 100 can automatically insert the estimated hold time into the message, e.g., at the end of the message, to say “The estimated hold time is 2 minutes.” The feature of the estimated hold time can be activated and/or deactivated by the user anytime before or during the receipt of an incoming call.

The display screen 112 may show an elapsed time indicator 422 that indicates how long the caller has been placed on hold. At anytime during the hold, the user can pick up the call (with an option 423) or re-direct the call to voicemail (with an option 424). If the option 424 is selected, a special voicemail greeting may be played to the caller to indicate that the user cannot pick up the call within a reasonable amount of wait time as he has previously expected. For example, the special voicemail greeting may indicate: “Sorry for the wait, but I cannot pick up your call at this time. Please leave a message after the tone.”

In one embodiment, the estimated hold time may be updated by the user while the incoming call is placed on hold. For example, after the call is on hold for 30 seconds, the user may realize that more or less hold time is needed. The user can change the hold time by moving the adjustment tab 421 on the slide bar to the right (e.g., more hold time) or to the left (e.g., less hold time). In response to the change of the hold time, the receiving phone 100 automatically announces to the caller the updated hold time estimate.

In some scenarios, the incoming call may arrive when the user is on another line of the receiving phone 100. Conventional phones provide a call waiting feature which allows the user to suspend the call in progress and switch to the incoming call. Instead of or in additional to the call waiting feature, the receiving phone 100 can continue the in-progress phone call without interruption, while holding the incoming call for the user. While holding the incoming call, the receiving phone 100 can play back a pre-recorded message to ask the caller to stay on the line until the user picks up the call.

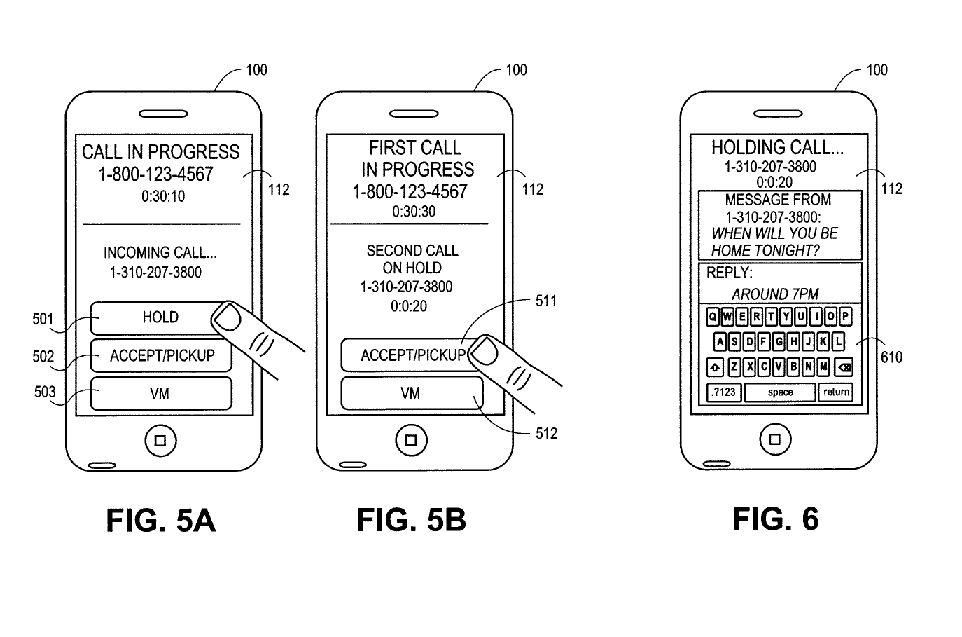

Referring to the example shown in FIG. 5A, the display screen 112 of the receiving phone 100 shows that an incoming call (the second call) arrives while another call (the first call) is in progress. In the example, the top portion of the display screen 112 shows the number (or a corresponding nickname) and the elapsed time (e.g., 30 minutes and 10 seconds) of the first call. The lower portion of the display screen 112 shows the number (or a corresponding nickname) of the incoming call, as well as a number of options (e.g. hold 501, accept/pickup 502, voicemail 503) for the user to handle the call. If the user selects the hold option 501, the receiving phone 100 answers the incoming call and plays a pre-recorded message while holding the incoming call on hold. The in-progress call is not interrupted by the incoming call. The receiving phone 100 may provide additional options, such as those described above in connection with FIGS. 4B and 4C, to the user for holding the phone. For example, the options can include a list of pre-recorded messages for the user to choose, such as those shown in FIG. 4B. The user can also pre-configure the receiving phone 100 to select a default message, or to associate selected contacts with particular default messages. The user can also enter an estimated hold time as shown in FIG. 4C, and the receiving phone 100 can incorporate the estimated hold time into the message played to the caller of the incoming call.

In an alternative scenario, if the user elects to pick up the incoming call, the first call will be placed on hold. The receiving phone 100 can play a pre-recorded message to the caller of the first call while holding the first call. In yet another scenario, if the user elects to re-direct the incoming call to voicemail, the voicemail system of the receiving phone 100 will pick up the incoming call, without interrupting the first call, for the caller of the incoming call to leave a message.

Referring to the example shown in FIG. 5B, after the user elects to hold the incoming call, the display screen 112 continues to show the telephone number of the in-progress call (the first call) and its elapsed time. Concurrently, the display screen 112 also shows the telephone number and the elapsed time of the call on hold (the second call), as well as options for the user to handle the second call. For example, at anytime during the first call is in progress, the user can select an accept/pickup option 511 to pick up the second call and place the first call on hold, or the user can select a voicemail option 512 to re-direct the second call to voicemail. The user can also select the accept/pickup option 511 to pick up the second call after the first call ends. Similar to the scenario described in connection with FIG. 4C, if the user elects to re-direct the second call to voicemail after the call has been placed on hold for a period of time, a special pre-recorded greeting may be played to the caller to apologize for the wait and ask the caller to leave a message.

In one embodiment, the first call and the second call shown in FIGS. 5A-5B can be handled simultaneously. That is, the receiving phone 100 may simultaneously handle two connections: one connection carries an uninterrupted in-progress call (the first call), and another connection carries an incoming call (the second call) to which the user can respond by entering text messages. Thus, the user of the receiving phone 100 can be texting using one connection while talking uninterruptedly using the other connection.

In one embodiment, the receiving phone 100 supports a speech-to-text feature. Referring back to FIG. 4B, after the user is alerted of the arrival of the incoming call, the user may choose to hold the call and select the “text” option 417 to activate the speech-to-text feature. Alternatively, the user may pre-configure the receiving phone 100 to activate the speech-to-text feature before an incoming call arrives. This feature can be useful when the user is unable to listen to the phone but is able to read text on the display screen 112. For example, the user may be in a meeting where he is not supposed to hold the receiving phone 100 to his ear, but he may read a text message without being noticed by other meeting attendees. If the user selects the “text” option 417, the receiving phone 100 will play a pre-recorded message to the caller, indicating that the user is temporarily unavailable to speak to the caller, but is able to send text messages. If the caller is calling from a device that has texting capabilities, the user and the caller can exchange text messages. If the caller is calling from a device (e.g., a plain landline phone) that cannot send and receive text, the caller can speak to the phone, and the receiving phone 100 automatically converts the caller's speech into words and shows the words on the display screen 112. The speech-to-text conversion may be performed by the speech-to-text converter 206 of FIG. 2.

In one embodiment, the receiving phone 100 may provide both text-to-speech conversion and speech-to-text conversion. If the caller is calling from a device (e.g., a plain landline phone) that cannot send and receive text, the receiving phone 100 can automatically convert the caller's speech into text and the automatically convert the user's text reply into speech for transmission to the caller. An example of this scenario is shown in FIG. 6.

Referring to the example shown in FIG. 6, the display screen 112 shows the telephone number of the call on hold and the elapsed time of the call. A panel of the display screen 112 shows a text message converted from the caller's speech, which may be “When will you be home tonight?” In response to the text message, the user can input a reply, e.g., “around 7 PM,” via a physical or a virtual keyboard 610 on a touch sensing panel of the receiving phone 100. The reply can be converted into speech signals and sent via the established communication link between the caller and the user.

In an alternative scenario, the message from the caller may be purely informational and does not request a reply from the user. For example, the caller may simply inform the user that the movie starts at 5 pm. In this alternative scenario, either or both parties to the call can hang up the phone once the text message is received from the caller.

In general, the receiving phone 100 (e.g., the telephone module 238) may be configured or programmed by the user to support one or more of the above-described phone hold features.

To conclude, various ways of holding an incoming telephone call in a portable communication device (e.g., a mobile phone) have been described. These techniques render a more user-friendly phone hold process for the user of a receiving phone. As explained above, an embodiment of the invention may be a machine-readable medium (such as memory 240) having stored thereon instructions which program a processor to perform some of the operations described above. In other embodiments, some of these operations might be performed by specific hardware components that contain hardwired logic. Those operations might alternatively be performed by any combination of programmed data processing components and custom hardware components.

The invention is not limited to the specific embodiments described above. Accordingly, other embodiments are within the scope of the claims.

What is claimed is:

1. A method of a portable communication device, the method comprising:
alerting a user of the portable communication device of an incoming call;
receiving an indication from the user to hold the incoming call, and in response, answering the incoming call and then playing back a pre-recorded message stored in the portable communication device to a caller of the incoming call;
while holding the incoming call, receiving an estimated hold time from the user and informing the caller of the estimated hold time; and
holding the incoming call until the user picks up the incoming call.

2. The method of claim 1, further comprising:
maintaining uninterrupted communication on a current call of the portable communication device, while answering the incoming call with the pre-recorded message and holding the incoming call.

3. The method of claim 1, wherein answering the incoming call further comprises:
playing back the pre-recorded message to request the caller to speak;
converting speech of the caller into text; and
displaying the text on a display screen of the portable communication device while holding the incoming call.

4. The method of claim 1, further comprising:
receiving a text input from the user while holding the incoming call; and
transmitting a signal representing the text input to the caller.

5. The method of claim 1, wherein receiving an estimated hold time further comprises:
receiving one or more taps from the user on a touch sensing panel of the portable communication device;
converting the one or taps into a length of time; and
incorporating the length of time into the pre-recorded message when answering the incoming call.

6. The method of claim 1, wherein receiving an indication from the user further comprises:
receiving, from the user, a selected message from a plurality of pre-recorded messages to play back to the caller.

7. A method of a portable communication device, the method comprising:
alerting a user of the portable communication device of an incoming call;
receiving an indication from the user to hold the incoming call, and in response, answering the incoming call and then playing back a pre-recorded message to request a caller of the incoming call to speak;
displaying the text converted from speech of the caller on a display screen of the portable communication device while holding the incoming call.

8. The method of claim 7, further comprising:
while holding the incoming call, receiving an estimated hold time from the user and informing the caller of the estimated hold time.

9. The method of claim 8, further comprising:
receiving one or more taps from the user on a touch sensing panel of the portable communication device;
converting the one or taps into a length of time; and
incorporating the length of time into the pre-recorded message when answering the incoming call.

10. A portable communication device, comprising:
a call notification mechanism to alert a user of the portable communication device of an incoming call;
an input interface to receive an indication from the user to hold the incoming call;
memory to store a pre-recorded message;
a sensor to be activated by a motion or a touch of the user to generate a sensor output;
a processor to convert the sensor output into a length of expected hold time; and
a telephone module to answer the incoming call in response to the indication from the user, then play back the pre-recorded message with the length of the expected hold time to a caller of the incoming call, and then hold the incoming call until the user picks up the incoming call.

11. The portable communication device of claim 10, wherein the telephone module is to maintain uninterrupted communication on a current call of the portable communication device, and, concurrently, to answer the incoming call with the pre-recorded message and hold the incoming call.

12. A portable communication device, comprising:
a call notification mechanism to alert a user of the portable communication device of an incoming call;
an input interface to receive an indication from the user to hold the incoming call;
memory to store a pre-recorded message that requests a caller of the incoming call to speak;
a telephone module to answer the incoming call in response to the indication from the user, to play back the pre-recorded message, and then to receive a speech of the caller while holding the incoming call;
a speech-to-text converter to convert the speech of the caller into a text message; and
a display screen to display the text message.

13. The portable communication device of claim 12, wherein the user interface comprises:
a touch sensing panel to receive input from the user and to generate a sensor output; and
a processor to convert the sensor output into a reply message to be sent in reply to the text message of the caller.

14. A machine-readable storage medium in which there is stored data that programs a portable communication device to:
alert a user of the portable communication device of an incoming call;
in response to input from the user to hold the incoming call, answer the incoming call and then play back a pre-recorded message stored in the portable communication device to a caller of the incoming call;
provide an adjustable visual indicator to the user while holding the incoming call for the user to enter an estimated hold time;
announce the estimated hold time to the caller while holding the incoming call.

15. The machine-readable storage medium of claim 14, in which there is stored data that programs a portable communication device to:
maintain uninterrupted communication on a current call of the portable communication device, while answering the incoming call with the pre-recorded message and holding the incoming call.

16. The machine-readable storage medium of claim 14, wherein to provide an adjustable visual indicator further comprises:
present a time indicator on a display screen of the portable communication device;
receive an adjustment to the time indicator from the user; and
convert the time indicator into the estimated hold time.

17. A machine-readable storage medium in which there is stored data that programs a portable communication device to:
alert a user of the portable communication device of an incoming call;
in response to input from the user to hold the incoming call, answer the incoming call and then play back a pre-recorded message to request a caller of the incoming call to speak;
receive speech of the caller and convert the speech into text; and
display the text on a display screen of the portable communication device while holding the incoming call.

18. The machine-readable storage medium of claim 17, wherein to display the text on the display screen further comprises:
receive text input from the user; and
convert the text input into speech signals for transmission to the caller.

19. The machine-readable storage medium of claim 17, in which there is stored data that programs a portable communication device to:
receive an estimated hold time from the user; and
inform the caller of the estimated hold time.

20. The machine-readable storage medium of claim 19, wherein to receive an estimated hold time further comprises:
receive one or more taps from the user on a touch sensing panel of the portable communication device;
convert the one or taps into a length of time; and
incorporate the length of time into the pre-recorded message when answering the incoming call.
